(19) United States
(12) Patent Application Publication
(10) Pub. No.: US 2005/0043953 A1
(43) Pub. Date: Feb. 24, 2005

(54) Dynamic creation of a conversational system from dialogue objects

(76) Inventors: Tiemo Winterkamp, Hennef (DE); Jorg Schulz, Rosrath (DE)

Correspondence Address: WORKMAN NYDEGGER (F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 10/490,884

(22) PCT Filed: Sep. 26, 2002
(86) PCT No.: PCT/EP02/10814

(30) Foreign Application Priority Data
Sep. 26, 2001 (DE) 101 47 341.9

(51) Int. Cl. G10L 11/00

(52) U.S. Cl. 704/275

(57) ABSTRACT

A technique for building up a dialogue control is provided. The dialogue control controls a computer system by outputting requests to a dialogue partner and evaluating input from the dialogue partner in reaction to the requests. An input is received from a user for selecting a dialogue object. A dialogue object is a data element with at least one data field, the contents of which specifying a request to the dialogue partner or a parameter influencing how an input from the dialogue partner is evaluated during execution of the dialogue control. Further, an input is received from the user for defining the content of at least one data field of the selected dialogue object. The dialogue object controls the computer system during execution of the dialogue control in dependence of the selected dialogue object and the defined content of the at least one data field of the selected dialogue object.

### CROSS-REFERENCE TO RELATED APPLICATIONS

Not applicable.

### BACKGROUND OF THE INVENTION

1. Field of the Invention

The present invention relates to a technique for forming (or building up) a dialogue control implemented in a computer system, and to an associated computer system. The invention particularly relates to building up voice-controlled services which can be provided to a dialogue partner to the computer system.

2. Description of the Related Art

Dialogue control systems and in particular voice control systems are at present applied in many business sectors. In this respect there are many applications which need voice-controlled interfaces to offer users services activated and controlled by voice. For example, in this way employees, partners and suppliers can access company information at any time. Also, processes and contact channels to customers can be improved. As a result, customer management solutions can be realized via voice control systems.

An example of the application of a speech control system is given in FIGS. 1a and 1b. In this example a municipal office offers administration services to individual residents. Using the telephone the resident dials a computer system operated by the municipal office or town hall and holds a dialogue with the computer system. The dialogue is based on spoken language so that the caller can verbally express his wishes and respond to questions presented and the computer system similarly responds verbally to the caller.

As can be seen in FIG. 1a, the caller first hears a welcoming message spoken by the computer in step 110. In the following step 120 the caller is then presented with a menu containing a number of options. The caller is requested to select one of these options and then speaks the corresponding word, which designates his desired selection, in step 130. Depending on the caller's selection, the computer system is then controlled to take a branch. If one of the designations in the menu is repeated by the caller, then the computer system branches to one of the subprocesses 140, 150, 160 or 170. After returning from the subprocess the caller is, where applicable, requested in step 180 to terminate the dialogue or to select another option. If the caller says the keyword intended to terminate the dialogue, then the computer system branches to a termination process 190, which finally terminates in the interruption of the telephone connection.

In FIG. 1b, as an example for the subprocesses 140, 150 and 160, subprocess 170 is shown in more detail and is used to show that a high degree of complexity can be achieved by repeated consecutive branching and user inputs. For example, the course of the dialogue control can have many through paths which can be rendered dependent on whether previous entries were able to be correctly processed. The subprocess can for its part again contain one or more menu selections which in turn branch to a large number of subprocesses.

It therefore becomes apparent that dialogue controls and especially voice controls can in individual cases be of a very complex structure, so that the formation of this type of dialogue control signifies an enormous effort in programming. The formation of dialogue controls is therefore also associated with high costs.

Another problem with the conventional programming of dialogue controls arises from the fact that dialogue controls must always be matched to the relevant fields of application. For example, different requirements arise for applications at a car rental company compared to those for a municipal office, because, apart from standard queries, also specific queries about the duration of the car rental period as well as a personalized traffic information service can be incorporated by the dialogue control. This includes, for example, the online interrogation of existing data bases. Other applications, such as applications in banks and insurance companies, airlines, airports, leisure companies, interview services, transport companies and in the tourism field, are in each case based on different prerequisites and therefore demand separate programming in each case. For example, multilanguage capability represents a concept which is practicable in many dialogue sequence applications, whereas in other applications it is only of marginal interest.

For the reasons mentioned, a substantial effort of programming is required for the realisation of a dialogue sequence control system according to the state of the art. In addition, for the realisation of a voice-controlled sequence control system, the particularly complex boundary conditions of voice control also arise. VoiceXML is already being applied in the state of the art for the standardisation of voice-controlled processes. VoiceXML is intended to enable the programming and the recall of web-based, personalized, interactive, voice-controlled services. A simple example of dialogue logic realized in VoiceXML is given by the following code:

```
<?xml version=“1.0”?>
  <vxml version=“1.0”>
    <form>
      <field name=“drink”>
        <prompt>
          Would you like coffee, tea, milk, juice or nothing?
        </prompt>
        grammar arc=“drink.gram” type=“application/x-jegf”/>
      </field>
      <block>
        <submit next=http://www.drink.example/drink2.asp”/>
      </block>
    </form>
  </vxml>
```

In this case “drink.gram” defines a grammar for describing the expected speech recognition result for the application fields recognized by the system. For example, the quoted grammer can comprise the selection options coffee, tea, milk, juice, etc., but also word combinations, homonyms and synonyms can occur.

The realisation of such voice controls places the requirement on the application designer for sufficient programming knowledge and adequate understanding of the various speech technologies to be applied. Voice controls can therefore only be realized with a large amount of effort and high costs.

### SUMMARY OF THE INVENTION

A technique for building up a dialogue control implemented in a computer system is provided which enables a simple and quick generation of a dialogue controlled service without requiring the user to have programming knowledge.

In one embodiment, a method is provided for building up a dialogue control implemented in a computer system. The dialogue control controls the computer system by outputting requests to a dialogue partner and evaluating input from the dialogue partner in reaction to the requests. The method comprises receiving an input from a user for selecting a dialogue object, wherein a dialogue object is a data element with at least one data field, the contents of which specifying a request to the dialogue partner or a parameter influencing how an input from the dialogue partner is evaluated during execution of the dialogue control. The method further comprises receiving an input from the user for defining the content of at least one data field of the selected dialogue object. The dialogue object is adapted to control the computer system during execution of the dialogue control in dependence of the selected dialogue object and the defined content of the at least one data field of the selected dialogue object.

In another embodiment, a computer program product has a storage medium for storing programming code containing instructions capable of causing a processor, when executing the instructions, to build up a dialogue control to be implemented in a computer system. The dialogue control controls the computer system to output requests to a dialogue partner and evaluate input from the dialogue partner in reaction to the requests. The dialogue control is built up by receiving an input from a user for selecting a dialogue object, wherein a dialogue object is a data element with at least one data field, the contents of which specifying a request to the dialogue partner or a parameter influencing how an input from the dialogue partner is evaluated during execution of the dialogue control; and receiving an input from the user for defining the content of at least one data field of the selected dialogue object. The dialogue object is adapted to control the computer system during execution of the dialogue control in dependence of the selected dialogue object and the defined content of the at least one data field of the selected dialogue object.

In yet another embodiment, an apparatus is provided for building up a dialogue control implemented in a computer system. The dialogue control controls the computer system by outputting requests to a dialogue partner and evaluating an input from the dialogue partner in reaction to the requests. The apparatus comprises a dialogue storage unit for storing dialogue objects, wherein a dialogue object is a data element having at least one data field, the content of which specifying a request to the dialogue partner or a parameter influencing the evaluation of an input from the dialogue partner during execution of the dialogue control, wherein the dialogue objects are adapted to control the computer system in dependence of a selected dialogue object and a defined content of at least one data field of the selected dialogue object during execution of the dialogue control. The apparatus further comprises an input unit for receiving an input for selecting a dialogue object and defining the content of the at least one data field of the selected dialogue object.

In a further embodiment, a computer system for executing a dialogue control comprises a request output unit for outputting requests to a dialogue partner, and an evaluation unit for evaluating input from the dialogue partner in reaction to requests. The computer system is arranged for executing the dialogue control in dependence of at least one dialogue object being a data element having at least one data field, the content of which specifying a request to the dialogue partner or a parameter influencing the evaluation of an input from the dialogue partner during execution of the dialogue control. The computer system is further arranged for executing the dialogue control in dependence of the content of at least one data field.

In still a further embodiment, a method of building up a dialogue control implemented in a computer system, is provided. The dialogue control controls the computer system by outputting requests to a dialogue partner and evaluating input from the dialogue partner in reaction to the requests. The method comprises receiving an input from a user for selecting a dialogue object being a data element with at least one data field, the contents of which specifying a request to the dialogue partner or a parameter influencing how an input from the dialogue partner is evaluated during execution of the dialogue control; receiving an input from the user for defining the content of at least one data field of the selected dialogue object, wherein the selected dialogue object is adapted to control the computer system during execution of the dialogue control in dependence of the selected dialogue object and the defined content of the at least one data field of the selected dialogue object; generating metadata based on the selected dialogue object and the defined content of at least one data field, wherein the metadata is suitable for generating programming code dynamically during run-time, and wherein execution of said programming code performs the dialogue control; and implementing the metadata in the computer system or an external data base.

### BRIEF DESCRIPTION OF THE DRAWINGS

The accompanying drawings are incorporated into and form a part of the specification for the purpose of explaining the principles of the invention. The drawings are not to be construed as limiting the invention to only the illustrated and described examples of how the invention can be made and used. Further features and advantages will become apparent from the following and more particular description of the invention, as illustrated in the accompanying drawings, wherein:

FIG. 1a is a flow chart which illustrates a voice-controlled dialogue sequence control;

FIG. 1b is a flow chart which illustrates a subprocess of the sequence shown in FIG. 1a;

FIG. 2a is a representation of a screen content for the entry of a data field content;

FIG. 2b is a representation of a screen content for the selection of a dialogue object;

FIG. 3 is a representation of a screen content for the reception of user entries according to another embodiment of the invention;

FIG. 4 illustrates the components which can be used for the implementation of the invention and for the realisation of the dialogue control according to this invention;

FIG. 5a is a flow chart which illustrates an embodiment of the method according to the invention for producing a dialogue sequence control;

FIG. 5b is a flow chart which illustrates an embodiment of the method according to the invention for implementing a dialogue sequence control;

FIG. 6a is a schematic representation of an embodiment of the prompt basis object;

FIG. 6b is a schematic representation of another embodiment of the prompt basis object;

FIG. 6c is a schematic representation of an embodiment of the sequence basis object;

FIG. 6d is a schematic representation of an embodiment of the conditional basis object;

FIG. 6e is a schematic representation of an embodiment of the entry basis object;

FIG. 7a to 7d are schematic representations of dialogue objects arranged higher in the object hierarchy; and

FIG. 8 is a representation of a screen content of object editor software according to an embodiment of the invention.

### DETAILED DESCRIPTION OF THE PREFERRED EMBODIMENTS

The illustrative embodiments of the present invention will be described with reference to the figure drawings wherein like elements and structures are indicated by like reference numbers.

Dialogue objects according to the invention are data elements which contain data fields. According to the invention, a number of dialogue objects are presented to the application designer (user) for selection which are explained in more detail below. Once the user has selected a dialogue object, he has the opportunity of completing the data fields of the selected dialogue object. The content of the data fields is used for adapting the relevant dialogue object to the specific dialogue application.

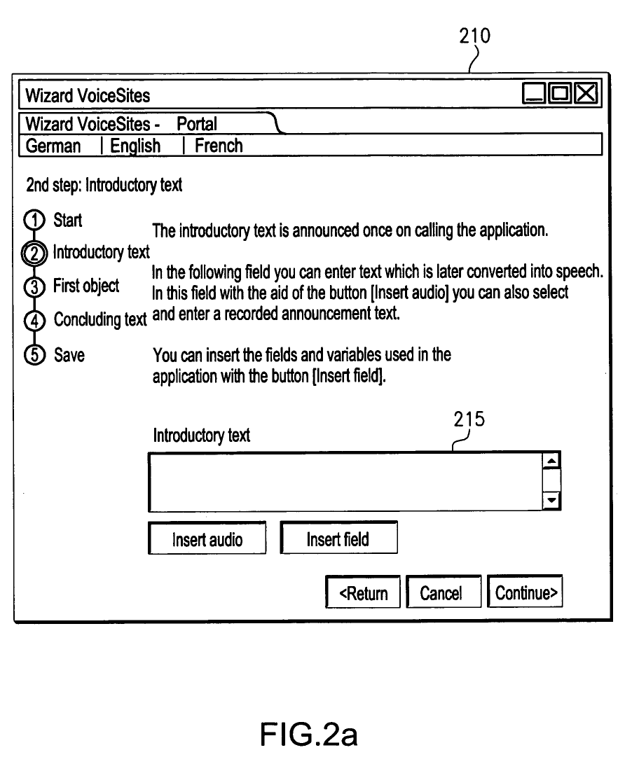

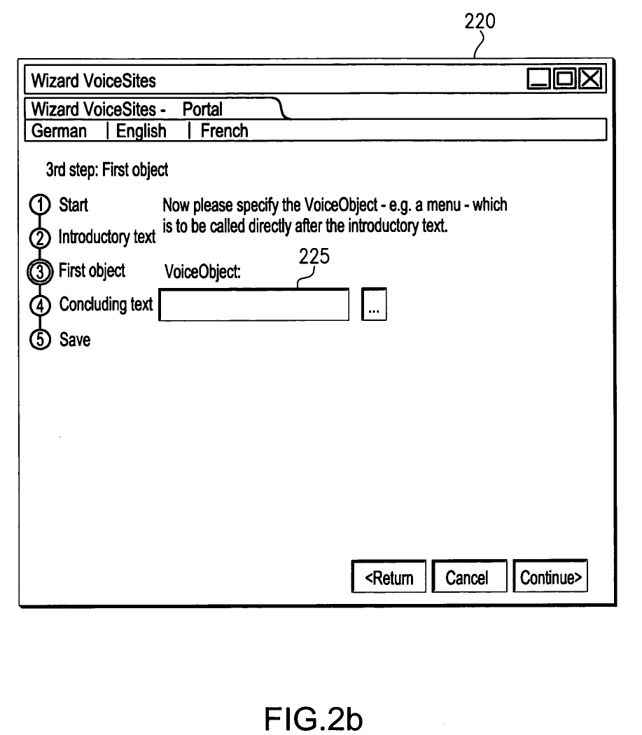

The process of selecting dialogue objects and completing data fields is now explained with reference to FIGS. 2a and 2b.

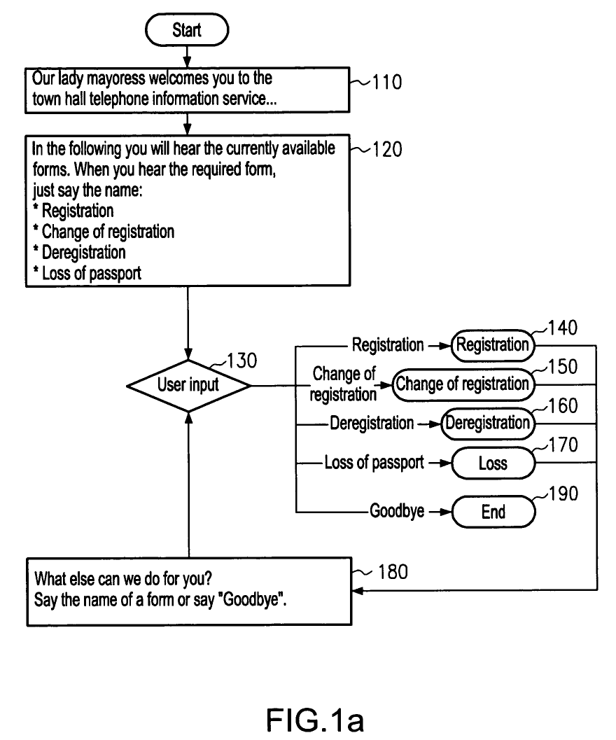

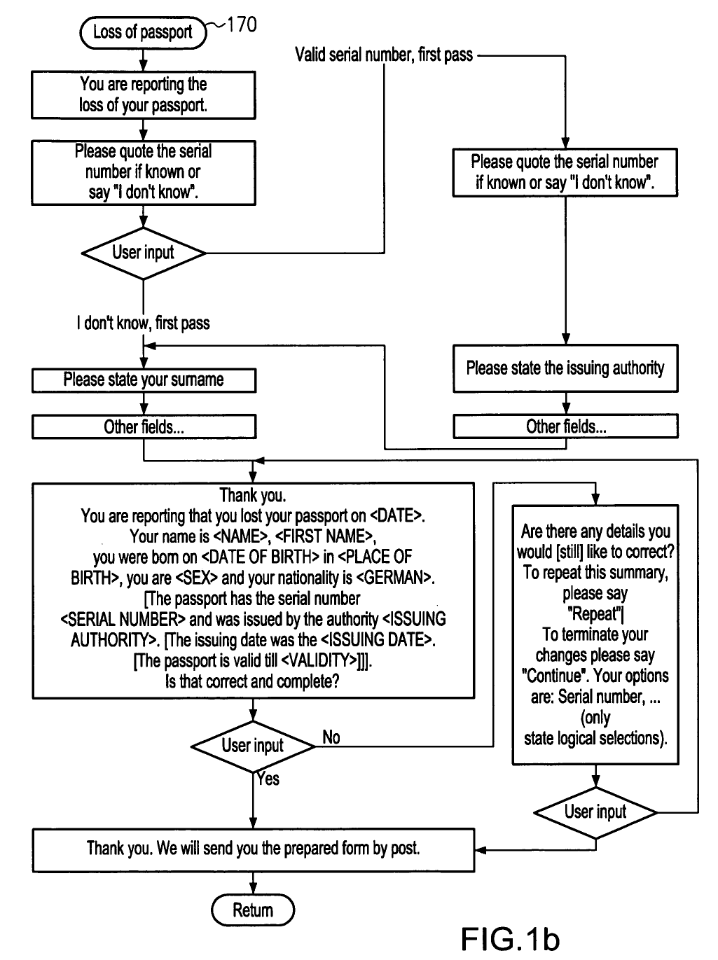

In FIG. 2a the user is presented with a screen display which guides him through the process of generating the dialogue control. When the user arrives at the second step “Introductory text” in which he can enter a text for the introduction, the user, by selecting the second step, has already selected the dialogue object “prompt” which is used to send the dialogue partner a message. The user can enter the message in the field 215. The data field of the prompt dialogue object is completed by entering a text in the field 215. For example, the user can enter in the field 215 the text “Our lady mayoress welcomes you to the town hall telephone information service” to define the voice announcement 110 in the example shown in FIG. 1a.

Whereas the selection of a dialogue object in FIG. 2a has occurred implicitly by control of step 2 of the generation procedure, the user, as shown in FIG. 2b, can also be offered a menu field 225, with which the user can explicitly select a number of dialogue objects. The selection can take place by picking an element of a displayed list of dialogue objects or also by entering the text of the name of the corresponding dialogue object.

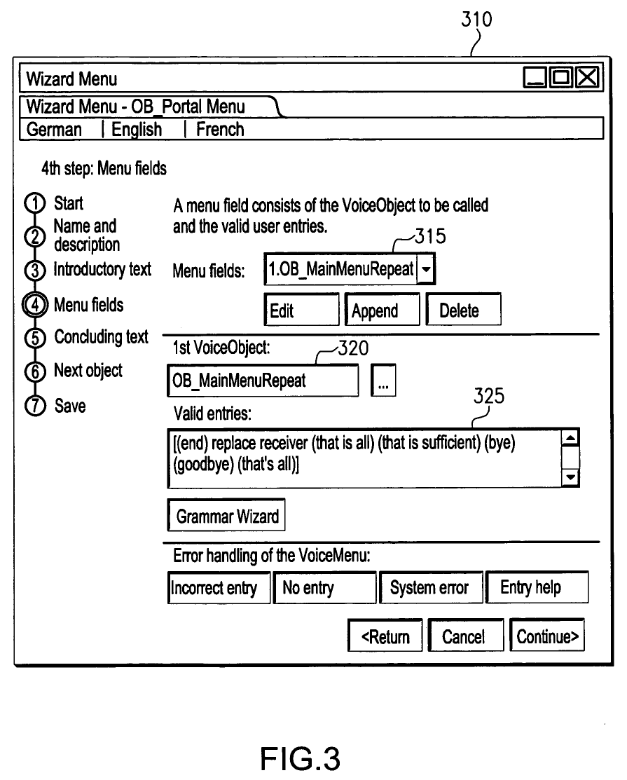

A detailed example of the selection of a dialogue object and entry of a content for the data field is shown in FIG. 3, where the menu fields 315, 320 and entry field 325 are made available to the user at the same time.

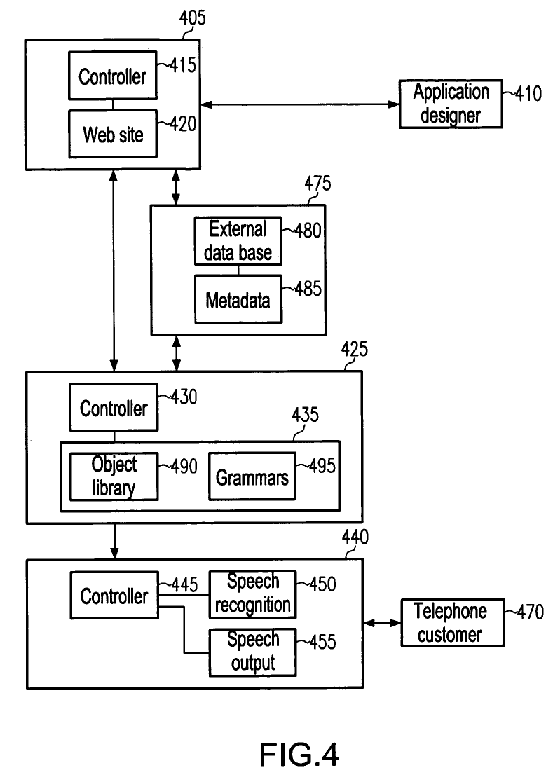

FIG. 4 shows the overall arrangement of system components for the implementation of the invention. An application designer 410 accesses, for example via the Internet, a web server 405 which presents the application designer the windows illustrated in FIGS. 2a, 2b and 3. The application designer 410 goes through the various steps in the production of the dialogue sequence control and then confirms the process. The controller 415 of the web server 405 then transfers the data, which the user has selected and entered, in the form of metadata to a further server 425. Alternatively, the metadata can be saved in a data base 485 of an external server 475 to which the server 425 has access.

The server 425 has a memory 435 in which the object library 490 and speech grammars 495 are saved. Together with control unit 430 of the server 425, the memory 435 therefore represents a generation subsystem which analyses the received metadata and generates a programming code which is then transmitted to the computer system 440. The analysis of the metadata and the generation and transmission of the programming code may occur dynamically, i.e., in run-time during the dialogue. The computer system 440 then carries out the dialogue with the dialogue partner 470 according to the instruction structure defined in the generated programming code.

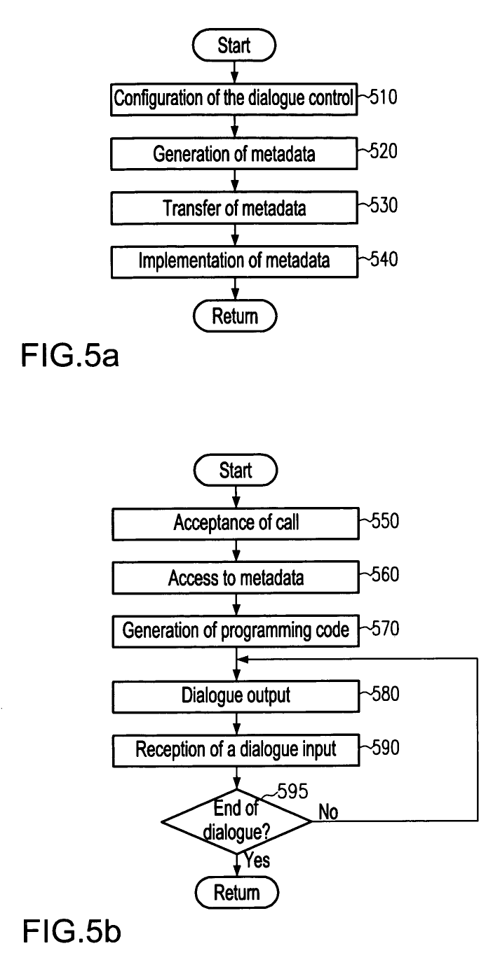

The individual methodical steps in the process for the generation of a dialogue control are shown in FIG. 5a. Once the application designer 410 has configured the dialogue control by the selection of dialogue objects and the completion of data fields, metadata is produced in step 520 by the web server 405 and transmitted to the server 425 or server 475 in step 530. The metadata is then implemented in step 540 by saving in a data base 485 or in the memory 435.

Although the methodical steps and system components according to the invention can be applied to all types of dialogue sequence controls, including a dialogue control by WAP terminal devices and other text and graphics-based communication devices such as SMS, EMS and MMS devices (Short, Extended and Multimedia Messaging Services), in the following the embodiment of the voice control is dealt with as an example. In this example the dialogue partner may be a telephone customer 470 who is in telephone contact with a computer system 440. For this purpose the computer system 440 has a speech recognition unit 450 and a speech output unit 455.

The process of implementing a dialogue control is illustrated in an embodiment in FIG. 5b. The speech recognition unit 450 receives the word spoken by the telephone customer 470 in step 550 as audio data, it analyses the audio sequence and generates data which can be processed by the controller 445 of the computer system 440. ASR systems (Automated Speech Recognition) can be used as the speech recognition unit.

Then in step 560 the controller 445 accesses the metadata saved in the memory 435 or in the data base 485 and in step 570 during run-time, i.e., dynamically generates the programming code necessary for the further voice and dialogue control.

The speech output unit 455 now carries out the speech output process in step 580 and generates audio signals which can be sent to the telephone customer 470. The speech output unit may be a speech synthesizing unit which generates a corresponding audio sequence from a sequence of letters. Such TTS systems (Text-To-Speech) produce a computer voice which as it were reads the entered text. The speech output unit can however also include play (or replay) software or hardware which (re)plays an audio file as required. Audio files are, for example, wav files.

Finally, step 595 determines whether the dialogue is to proceed and branching back to step 580 occurs accordingly. In an alternative embodiment branching back to step 560 occurs, namely when further metadata is to be read for the continuation of the dialogue.

In an embodiment of the invention the speech recognition unit 450 and the speech output unit 455 are encapsulated by a VoiceXML layer or engine implemented in the controller 445 and these are now addressed.

Depending on the possibility of arranging speech output through speech synthesis or replaying of an audio file, the application designer 410 is given the possibility during the generation of the voice-controlled dialogue sequence control, of entering a text as a sequence of letters or of selecting or loading an audio file. As can be seen in FIG. 2a, the application designer 410 can realise both possibilities by entries in the field 215 or by selecting the button situated below it. The corresponding data field of the dialogue object then saves either a letter sequence, which is speech synthesized by the TTS system, or an audio file or a reference to such a file.

As already mentioned and as can be seen from FIG. 5b, the programming code is generated dynamically. This automatic dynamic generation may also include the generation of the grammar components 495 required for the dialogue guidance. The generation of the grammar components may take place based on VoiceXML specifications.

Grammars can be saved as static elements for dialogue objects, but they can also be dynamic. With static grammars the content, i.e., the word sequences to be recognized, are already known at the time the dialogue control is produced. The grammars can also be, where necessary, translated beforehand. They are then passed directly to the server 440.

Dynamic grammars are first generated at run-time, i.e., during the dialogue. This is, for example, of advantage when an external data base must be accessed during the dialogue and the results of the interrogation are to be made available to the dialogue partner as a menu. In such cases the possible response options are generated in the form of a grammar from the data interrogated from the data base in order to then supply the speech recognition unit 450. Furthermore, dynamic grammars permit modification of the sequence characteristics of dialogue objects during the dialogue. For example, changeover between the familiar and impersonal forms of “you” (“du” and “Sie” in German) can be made in the dialogue.

In the following, dialogue objects are explained in more detail with an example of speech objects. Apart from a header containing the name of the dialogue object, this type of dialogue object has a number of segments, namely an output data field, an input data field, a response options data field, a grammar data field and a logic data field. All these segments contain information which provide a request to the dialogue partner or a parameter which influences the evaluation of an entry from the dialogue partner during the execution of the dialogue control.

The output data field contains the dialogue text which is to be transmitted as speech to the telephone customer. As already mentioned, the output can take place using different output terminal devices 455. Apart from the previously mentioned speech synthesis and replay devices, the output can also be made as text output on a monitor. For example, a telephone display can be used for this purpose. A dialogue object may have none, one or more output options.

The entry data field defines response fields, variables or other elements which can control the sequence of the voice dialogue. In particular, the returns from the speech recognition device 450 are accepted here.

The response options data field saves the response options within a dialogue component. These can be presented to the user according to the selected output medium or also be accepted implicitly. For example, response options may be present in the form of a spoken list of terms via TTS, but also as a list on a telephone display. Implicit response options are, for example, possible with the query “Is that correct?”, because in this respect the possible responses do not need to be previously spoken to the dialogue partner. In particular, response options determine the alternatives for the dialogue branching for the application developer and the decision basis for the dialogue system.

In the dialogue object, grammars define the accepted expressions for a dialogue step, for example, the possible responses to a query. In this connection, grammar is taken to mean the ordered relationship between words, word chains or phrases within an expression. Grammars can be described in a Backus-Naur form (BNF) or in a similar symbolic notation. In the context of VoiceXML a grammar describes a sequence of words to be spoken which are recognized as a valid expression.

An example of a grammar is given in the following:

```
Nationality
[
  [finnish finland finn]
    {<sltNationality “finnish”>}
  [swedish sweden swede]
    {<sltNationality “swedish”>}
  [danish denmark dane]
    {<sltNationality “danish”>}
  [irish ireland irishman irishwoman]
    {<sltNationality “irish”>}
  [british england english englishman englishwoman]
    {<sltNationality “english”>}
  [dutch netherlands holland the netherlands dutchman dutchwoman]
    {<sltNationality “dutch”>}
  [belgian belgium]
    {<sltNationality “belgian”>}
  [luxembourgian luxembourg luxembourgois]
    {<sltNationality “luxembourgian”>}
  [french france frenchman frenchwoman]
    {<sltNationality “french”>}
  [spanish spain spaniard]
    {<sltNationality “spanish”>}
  [portuguese portugal]
    {<sltNationality “portuguese”>}
  [italian italy]
    {<sltNationality “italian”>}
  [greek greece]
    {<sltNationality “greek”>}
  [german germany]
    {<sltNationality “german”>}
]
```

Another example of the entry of a grammar by the application designer is given in FIG. 3 in field 325. The grammars defined in the dialogue object may be present in any context-free form, particularly in the form of a preconfigured file. Here, the grammars are not restricted to the response options of the appropriate dialogue object, but rather they can also include other valid expressions from other, in particular hierarchical, higher level dialogue objects. For example, a dialogue can contain a general help function or also navigation aids such as “Proceed” and “Return”.

The logic data field defines a sequence of operations or instructions which are executed with and by a dialogue object. The operations or instructions can be described in the form of conditional instructions (conditional logic), they can refer to the input and output options, contain instructions and refer to other objects. A dialogue object can have a number of entries in the logic data field. These are normally executed sequentially. Essentially, the logic data field represents the reference of the dialogue objects with respect to one another and furthermore also the relationship to the external processes. Through these, so-called connectors are realized which can also control external processes via input and output segments.

This control can, for example, include an external supply of data from a data base 480. The external data base 480 can exhibit a link to the servers 405 and 425 and it enables the use of external data sources such as relational data bases, SAP systems, CRM systems, etc. The link of the external data sources to the server 405 is used, for example, for the realisation of the connectors by the application designer. The link of the external data source to the server 425 can be used for the generation of the dynamic grammars.

All data fields of a dialogue object can also reciprocally not be present. Therefore, a dialogue object may also only consist of an output or an input or also only of logic elements. The presence of data fields within a dialogue object later also defines its behaviour within the dialogue. If, for example, a grammar and an input option are present, then an entry is expected which is to be recognized as specified by the grammar.

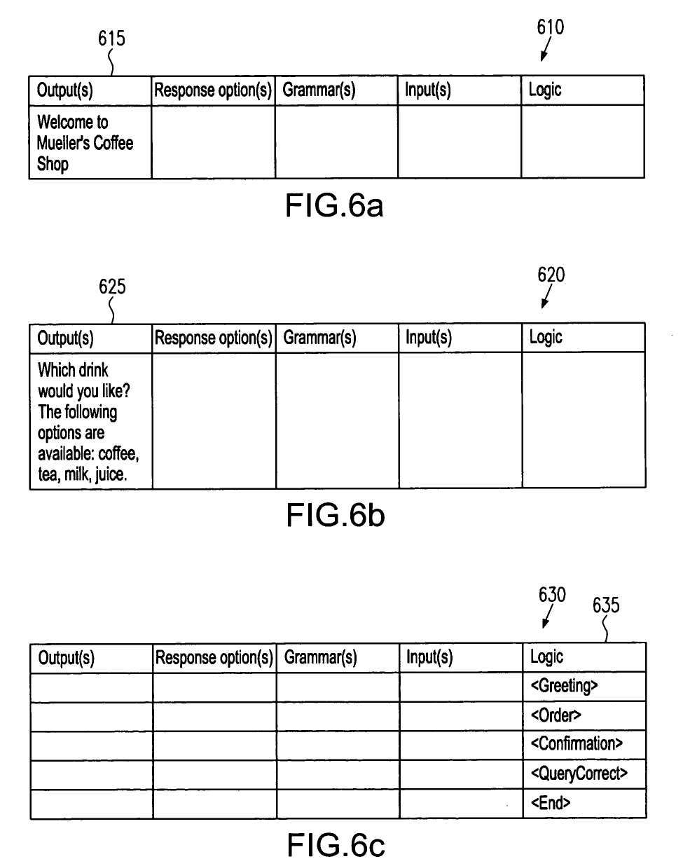

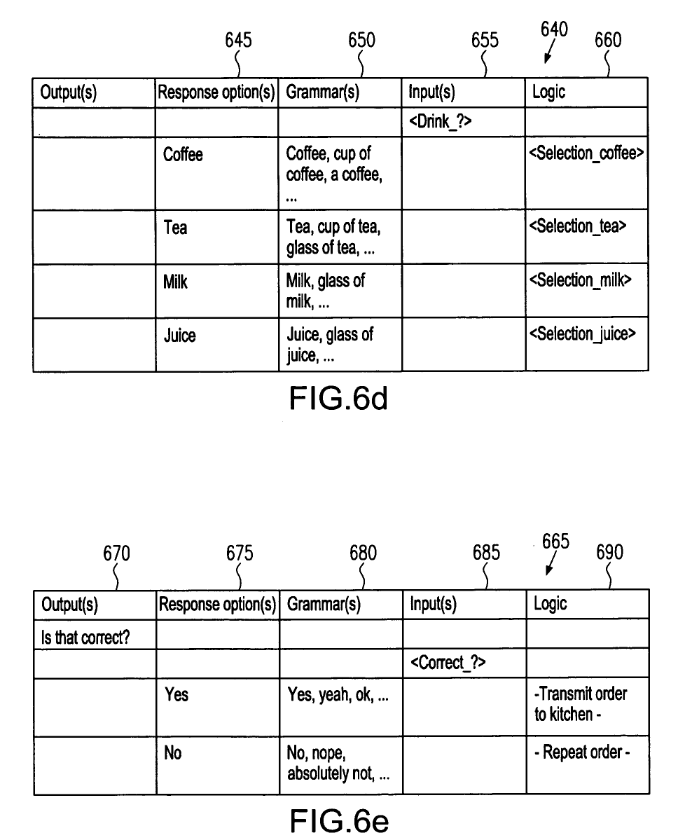

FIGS. 6a to 6e show examples of simple basic objects which represent the basis also for the generation of further dialogue objects.

FIG. 6a shows a dialogue object 610 which consists of a simple message “Welcome to Mueller's Coffee Shop”. This dialogue object has been generated from the basic object “prompt” by completion of the output data field. The prompt data object generally enables the output of a text passage without requesting the dialogue partner to enter a response.

FIG. 6b shows another dialogue object 620 which only exhibits contents in the output data field. The dialogue object shown in FIG. 6b outputs a query and gives possible responses to the dialogue partner. Also the dialogue object shown in FIG. 6b is based on the prompt dialogue object, although the output requests the dialogue partner to enter a response. The treatment of the response is however defined in a following dialogue object.

Here it will be appreciated that it is necessary to define a sequence of dialogue objects. This is illustrated in FIG. 6c with the dialogue object 630 which shows an example of the sequence dialogue object. The sequence defined in the logic data field for the sequence control of the dialogue flow defines a hierarchy which will be run through by the dialogue partner. In the example in FIG. 6c no conditional logic is therefore defined.

The dialogue object 640 shown in FIG. 6d consists of a series of response options, grammars and logic instructions via which the dialogue branching can take place in the sense of conditional logic. The dialogue object 640 is therefore an example of a conditional dialogue object and is suitable for the conditional sequence control in dependence of the recognized input, for example via ASR, by the telephone customer. All the necessary response options and combinations are, for example, passed to the speech recognition system 450 in the form of a grammar. After the recognition process this returns only the corresponding response option as a decision-making basis. The dialogue continues where the variable <drink_?> is equal to the selection option, whereby the logic determines which instruction is executed. In the example shown in FIG. 6d the executing instruction is in each case a simple jump.

Another dialogue object based on a basic object is shown in FIG. 6e. The dialogue object 665 consists of a simple announcement, a prompt and an expected answer. The input dialogue object on which it is based is suitable for simple queries and can be used as a standard element for various situations.

Other simple basic objects for the construction of loops, explicit conditional logic, links to in-coming or outgoing data flows, etc. can be similarly constructed. These dialogue objects are also made available to the application designer in the standard selection.

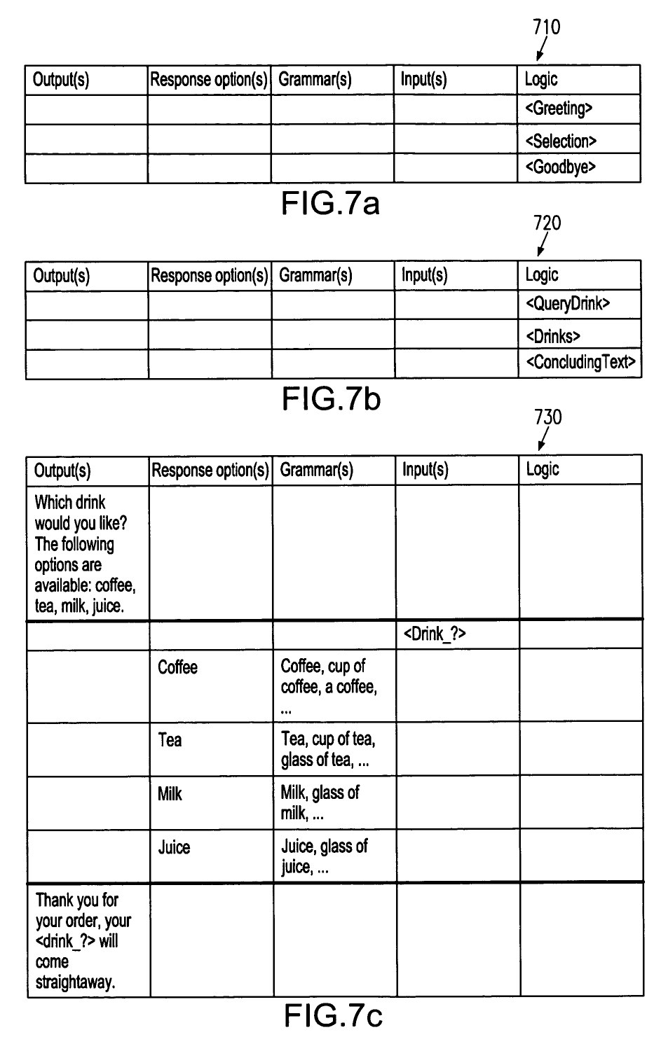

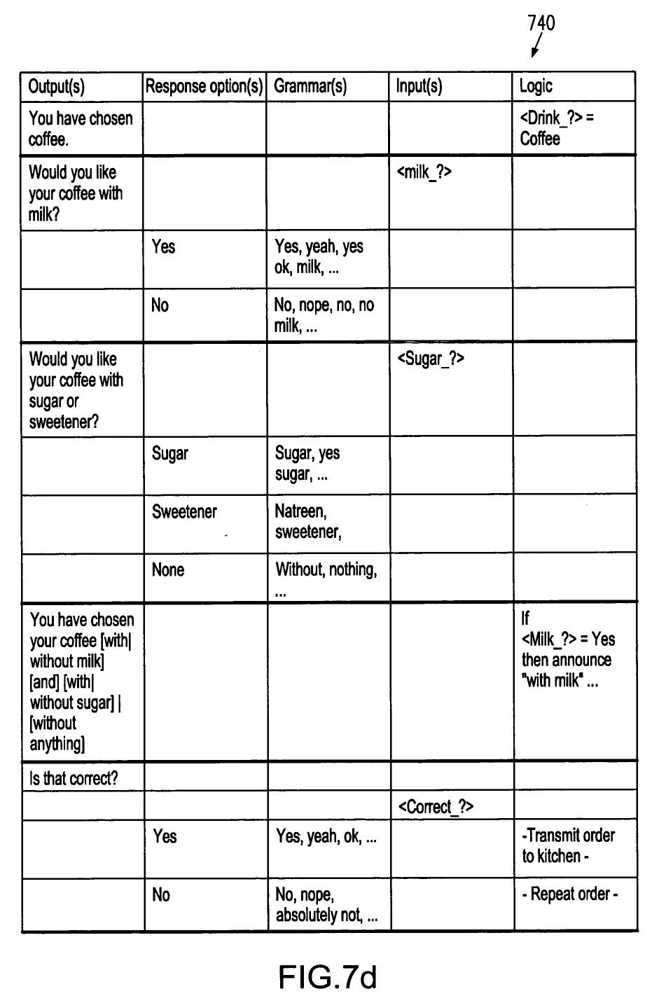

Examples of higher level dialogue objects are shown in FIGS. 7a to 7d. These dialogue objects can be quickly and simply defined to the basic objects described above, so that dialogue objects can be generated by the application designer which are more like the logic dialogues and partial dialogues of a communication with a person.

FIG. 7a shows a dialogue object 710, which contains a sequence for the sequence control, which includes a call of a prompt for greeting, a call of a selection in an order form and a call of a prompt for saying goodbye. This dialogue object is therefore an example of a basic structure of dialogue applications, which, for example, can be generated in the manner described in FIGS. 2a and 2b. The dialogue object 710 is equivalent to the dialogue steps of a greeting “Welcome to Mueller's Coffee Shop”. Thereafter, branching occurs directly to the dialogue object for a drink selection and the dialogue continues accordingly. On returning from the quoted dialogue object, the second announcement “Goodbye till next time. We hope to see you again soon.” then occurs.

The dialogue object 720 shown in FIG. 7b also consists of a sequence for the sequence control. The sequence contains a call of a prompt, which announces the available options, a call of a conditional branch for executing the menu selection and a call of a prompt for saying goodbye. The dialogue object 720 is based on the menu dialogue object 640 which generally permits the output of a text passage, the stating of the response options for dialogue branching, the stating of a grammar for response recognition, etc. and in this way, enabling the application designer to quickly link partial dialogues to a complete overall dialogue.

If the dialogue object 720 shown in FIG. 7b is represented without a sequence dialogue object, the representation shown in FIG. 7c is produced. This dialogue object 730 could then be equivalent to the following dialogue:
Computer system: “Which drink would you like? The following options are available: coffee, tea, milk, juice.”
Telephone customer: “Coffee.”
Computer system: “Thank you for your order, your <drink_?> will come straightaway.”

The dialogue can be extended, of course. For example, a jump can be made to a separate selection for further queries after the drink has been recognized, as shown in FIG. 7d.

The dialogue object 740 shown there comprises a sequence for the sequence control with a call of a prompt for introduction, a call of a conditional interrogation for milk selection, a call of a conditional interrogation for sugar selection, a call of a dialogue object for the summary of the order and a call of an input dialogue object for the query of whether all the data has been correctly acquired. The dialogue object shown in FIG. 7d replicates, among other things, the following example dialogue:
Computer system: “You have chosen coffee. Would you like coffee with milk?”
Telephone customer: “Yes.”
Computer system: “Would you like your coffee with sugar or sweetener?”
Telephone customer: “Sugar.”
Computer system: “You have chosen your coffee with milk and sugar.”
Computer system: “Is that correct?”
Telephone customer: “Yes.”

As the above makes clear, the invention enables the formation of a dialogue control implemented in a computer system by the selection of dialogue objects and the completion of data fields of the selected dialogue objects. The selection and completion is facilitated for the user using a software platform, so that the application designer does not need any specific programming knowledge. For further simplification a software-based help assistant can be made available to the application designer in the form of a wizard, as shown in FIGS. 2a, 2b and 3, which explains the possible options for the further procedure at any time point. For advanced application designers an expert mode can be provided which enables the direct input of the data using an editor. Furthermore, the selection of a dialogue object and the completion of a data field can also occur using a script language.

As previously described, the dialogue objects defined by the application designer are transmitted as metadata to the server 425 or 475, whereby the server 425 then dynamically generates a programming code, for example based on the VoiceXML standard, with the aid of object and grammar libraries. In another embodiment the programming code generation is executed directly by the web server 405 or by the computer system 440, so that a separate server 425 does not need to be provided. Also the server 475 can be realized on one of the other servers or computer systems and therefore also does not need to be provided separately. And again in another version, the server 425 can be a Java application server.

As described based on the examples in FIGS. 6a to 6e and 7a to 7d, the application designer can produce high level dialogue objects based on basic objects. The basic objects and high level dialogue objects may be saved in an object-orientated program structure with inherited characteristics.

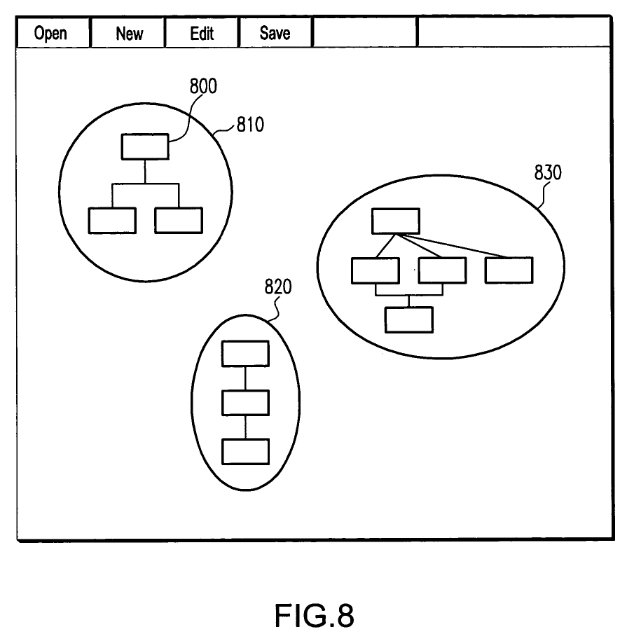

An example of the editing of objects by the developer or administrator can be seen in FIG. 8. For this purpose, software may be used which runs on the server 405 and presents the administrator with a monitor display representing the various objects 800 for visual cognition. The objects can be hierarchically displayed as a tree structure to represent the sequence control. In FIG. 8 for example, the structure 810 corresponds to a menu dialogue for the selection of alternative dialogue paths, for example, using the menu object. The structure 820 represents an instruction sequence for the definitive execution of dialogue steps, for example, for access to a data base. In contrast the structure 830 represents a query dialogue for completion of the data fields. The objects 800 connected together in the structures can, for example, be selected by mouse click to be modified, supplemented, deleted or moved.

In an embodiment the dialogue objects and the computer system are set up to personalise the dialogue with the dialogue partner. In this respect, the computer system 440 determines a profile of the dialogue partner 470, based on personal information, which may be stated by the user. This may include, for example, the age, sex, personal preferences, hobbies, mobile telephone number, e-mail address, etc. through to relevant information for the processing of the transaction in the M-commerce field, namely account information, information about mobile payment or credit card data. The personalisation of the dialogue can also occur dependent on the location of the dialogue partner or on other details such as payment information. If, for example, payment information is available, the user can enter directly into a purchasing transaction. In other cases, an application might not permit this option and perhaps first acquire the data and have it confirmed. Another alternative is offered by information on gender and age. Speech applications may here act with different interface figures. For example, the computer voice speaking to the dialogue partner 470 can take on a fresh, lively and youthful sound applicable to a younger subscriber.

Another embodiment of the invention provides for the possibility that not just the dialogue but also the method according to the invention for the formation of a dialogue control can be carried out via the telephone. For example, the application designer 410 produces a dialogue control via a web site on the web server 405, enabling the telephone customer 470 to complete data fields. This type of generated dialogue application can, for example, enable the telephone customer 470 to configure a virtual answering machine (voicebox) located in the network. In this respect, the application designer 410 provides a dialogue object which requests the telephone customer 470 to record a message. The message is then saved in a data field of another dialogue object.

Another embodiment of the invention provides for the possibility of generating metadata based on the selected dialogue object and on the content of data fields, whereby programming code is generated using metadata dynamically during run-time, i.e., during the execution of the dialogue control, the programming code being compatible to a format for the use of standard IVR (Interactive Voice Response) or voice dialogue or multimodal dialogue systems. In a further step this metadata may then be implemented in the computer system or an external data base (485). Alternatively, the programming code is generated in a standard machine language for dialogue processing in a telephony system, for instance in a SALT code (Speech Application Language Tags) or in a WML code.

Another alternative of this embodiment of the invention provides for the possibility that the dialogue object detects events generated by other dialogue objects or by the computer system and/or executes the dialogue control in dependence of detected events. In this way external events, also of an asynchronous nature, are directly integrated into the dialogue sequence.

For the integration of events into a chronologically scheduled dialogue sequence, the control unit 430 must be able to deal with events which do not take place in a direct connection. In particular an external “call function”, i.e., reacquisition of the dialogue, must acquire the dialogue in a desired modality or in a modality just possible in the situation. For this purpose, the dialogue object is equipped to save a status of the dialogue control, to interrupt the dialogue control in dependence of a first detected event and to continue the dialogue control using the saved status in dependence of a second detected event.

An additional alternative to this embodiment of the invention provides for orthogonal characteristics for dialogue objects which may relate to characteristics for auxiliary, error-handling, speech and speech character functions (persona). These object characteristics may be saved in objects in the form of metadata and therefore as orthogonal characteristics they can also be handed down to following dialogue objects. However, they can also be superimposed by other details or characteristics. These characteristics can be modified at the dialogue run-time/call time. Just and in particular during the running dialogue. This applies, for example, to languages (e.g., from English to German to French—with appropriate system and object configurations) or persons. (from male to female speakers and vice versa).

With the embodiments of the invention described above, the central storage of the dialogue object in the form of a central well-defined metadata description in a data base 485 has the advantage of a controlled development of objects and their version adaptation for an application, also beyond application boundaries. The developer can access this version adaptation via a graphical interface 420 of the web server 405. Well-defined metadata here enables well-defined interactive mechanisms amongst dialogue objects, for interaction with various interfaces to graphical user interfaces 405 and for interaction with various interfaces for the control unit 430 internal to the system.

Furthermore, the use of the metadata from the central register enables a consistent, well-defined extraction of dialogue objects for the generation of programming code at run-time—or more precisely, at dialogue/call time. The central management of metadata in a data base 480 enables the on-going, i.e., continuous and generally—and particularly in the case of an emergency—unmodified storage of the complete object information and in the end also the voice application/speech application. As a result, the application reliability is noticeably improved with respect to the availability of an application. This is an important aspect for use in the field of telephony applications, because here there is an expectation of 100% availability of telephony services.

Well-defined central metadata enables an extension (upgrade) of the metadata structure through central mechanisms. Dialogue objects can be adapted uniformly and quickly to the current technology standard without having to interfere with the logic/semantics of objects. The storage (480) occurs especially independently of the data base structure, so that storage can also occur over distributed systems.

As apparent from the above description of the various embodiments, dialogue sequence control systems can be formed from reusable dialogue objects which can be specifically adapted to the relevant application by the completion of data fields in the dialogue objects. Since this can be realized using a simple software platform, the user who would like to design a voice-controlled application, can set up the sequence control in a simple manner without detailed knowledge of speech technologies. Consequently, the application designer is offered an increased productivity with an improved service. Furthermore, the costs for the generation of a dialogue application are reduced.

The application of dialogue objects also enables free scaling of the application. As a result, dialogue controls can be generated in a simple manner which exhibit a high degree of complexity and which are nevertheless specifically adapted to the relevant process. In this connection companies and organisations, which have previously not implemented a dialogue control for reasons of complexity, can automate their business processes to a great extent, increase their production and improve the value add chain.

Advantages arise due to the dynamic generation of the programming code required for the implementation of the dialogue during run-time, i.e., during the initialisation of the dialogue. Because of this, on one hand, the system resources are significantly relieved during the generation of the dialogue control. Principally, however, there is the advantage that existing dialogue controls already produced can be adapted simply and in an automated way to new circumstances and, for example, be supplemented with new grammars. This adaptation can therefore also occur during the dialogue.

The embodiments are furthermore of particular advantage in the generation of a voice control, because, as explained above, the realisation of a conventional voice control is associated with particularly complex programming technologies. Through the generation of voice dialogues, telephone voice systems, and also voice-activated data services can be realized over the Internet or in the client-server mode in a simple manner.

While the invention has been described with respect to the physical embodiments constructed in accordance therewith, it will be apparent to those skilled in the art that various modifications, variations and improvements of the present invention may be made in the light of the above teachings and within the purview of the appended claims without departing from the spirit and intended scope of the invention. In addition, those areas in which it is believed that those of ordinary skill in the art are familiar, have not been described herein in order to not unnecessarily obscure the invention described herein. Accordingly, it is to be understood that the invention is not to be limited by the specific illustrative embodiments, but only by the scope of the appended claims.

1-49. (cancelled)

50. (new) a method of building up a dialogue control implemented in a computer system, said dialogue control controlling the computer system by outputting requests to a dialogue partner and evaluating input from the dialogue partner in reaction to the requests, the method comprising:
receiving an input from a user for selecting a dialogue object, a dialogue object being a data element with at least one data field, the contents of said at least one data field specifying a request to the dialogue partner or a parameter influencing how an input from the dialogue partner is evaluated during execution of the dialogue control; and
receiving an input from the user for defining the content of at least one data field of the selected dialogue object,
wherein the dialogue object is adapted to control the computer system during execution of the dialogue control in dependence of the selected dialogue object and the defined content of the at least one data field of the selected dialogue object.

51. The method of claim 50, wherein the dialogue control is a voice control controlling the computer system by outputting spoken requests to a dialogue partner and evaluating spoken input from the dialogue partner in reaction to the spoken requests.

52. The method of claim 51, wherein the content of at least one data field of the selected dialogue object is defined by inputting a sequence of letters suitable for being converted into spoken language by a device of the computer system for speech synthesis during the execution of the dialogue control, and outputting the converted sequence of letters to the dialogue partner.

53. The method of claim 51, wherein the content of the at least one data field of the selected dialogue object is defined by inputting an audio file or a reference link to an audio file, said audio file being suitable for being played by an audio file play unit of the computer system, and outputting the audio file to the dialogue partner.

54. The method of claim 50, further comprising:
generating meta data based on the selected dialogue object and the defined content of at least one data field, said meta data being suitable for generating programming code dynamically during run-time, i.e. during execution of the dialogue control, wherein execution of said programming code performs the dialogue control; and
implementing the meta data in the computer system or an external data base.

55. The method of claim 54, wherein the programming code is a VoiceXML (Voice Extensible Markup Language) code.

56. The method of claim 50, wherein the dialogue control implemented in the computer system is a text-based dialogue control in a computer network or a mobile radio network.

57. The method of claim 56, wherein the text-based dialogue control implemented in the computer system is adapted for communication with the dialogue partner according to the WAP (Wireless Application Protocol) protocol.

58. The method of claim 50, wherein the steps of receiving an input comprise:
providing an HTML (Hypertext Markup Language) page having a menu or input field for the selection of the dialogue object or the definition of the content of the at least one data field.

59. The method of claim 50, wherein the steps of receiving an input comprise:
receiving a spoken input via a telephone line.

60. The method of claim 50, further comprising:
storing an identifier of the selected dialogue object and of the content of the at least one data field of the selected dialogue object in a data base.

61. The method of claim 50, wherein the dialogue object is a dialogue object selectable from a plurality of dialogue objects and the plurality of dialogue objects comprises a menu object which, during the execution of the dialogue control, causes the computer system to output a request to the dialogue partner for the selection of one of a plurality of menu options.

62. The method of claim 50, wherein the dialogue object is a dialogue object selectable from a plurality of dialogue objects and the plurality of dialogue objects comprises a prompt object which, during the execution of the dialogue control, causes the computer system to output a message to the dialogue partner without requesting an input.

63. The method of claim 50, wherein the dialogue object is a dialogue object selectable from a plurality of dialogue objects and the plurality of dialogue objects comprises a conditional object which, during the execution of the dialogue control, causes the computer system to allow for a conditional sequence control in dependence of an evaluated input from the dialogue partner.

64. The method of claim 50, wherein the dialogue object is a dialogue object selectable from a plurality of dialogue objects and the plurality of dialogue objects comprises a query object which, during the execution of the dialogue control, causes the computer system to output a query to the dialogue partner and receive and evaluate a response from the dialogue partner.

65. The method of claim 50, further comprising:
receiving an input from the user for selecting a sequence dialogue object having at least two data fields for storing identifiers of other dialogue objects, thereby specifying an execution sequence of the dialogue objects.

66. The method of claim 50, wherein the dialogue object further has a data field for storing conditional instructions.

67. The method of cliam 50, wherein the dialogue object further has a data field for storing different input data received from the dialogue partner, said different input data being to be evaluated by the computer system as being equivalent data.

68. The method of claim 50, wherein the dialogue object further has a data field for storing different input data received from the dialogue partner, said different input data being to be evaluated by the computer system as different responses to a request.

69. The method of claim 68, wherein the dialogue object is adapted to cause the computer system, during the execution of the dialogue control, to display a plurality of possible input data on the display of a telephone, PDA (Personal Digital Assistant) or SmartPhone of the dialogue partner.

70. The method of claim 67, wherein the dialogue object is adapted to cause the computer system, during the execution of the dialogue control, to start an error handling routine if after the evaluation of an input from the dialogue partner, none of the possible inputs could be determined.

71. The method of claim 50, wherein the dialogue objects are organized in an object-orientated program structure having an inheritance hierarchy.

72. The method of claim 71, further comprising:
receiving an input from the user for generating a dialogue object based on the selected dialogue object.

73. The method of claim 50, wherein the dialogue object is adapted to cause the computer system to execute the dialogue control in dependence of a personal profile of the dialogue partner.

74. The method of claim 50, wherein the steps of receiving an input are performed under the guidance of a help assistant realized in software.

75. The method of claim 50, wherein the steps of receiving an input are performed with the aid of a text editor.

76. The method of claim 54, whereby the generated programming code is a SALT (Speech Application Language Tags) code.

77. The method of claim 54, whereby the generated programming code is a WML (Wireless Markup Language) code.

78. The method of claim 50, further comprising:
generating meta data on the basis of the selected dialogue object and the defined content of the at least one data field, the meta data being data suitable for generating programming code dynamically at run-time, i.e. during the execution of the dialogue control, said programming code being compatible to a format for the use of standard IVR (Interactive Voice Response) or voice dialogue or multimodal dialogue systems.

79. The method of claim 78, further comprising:
implementing the meta data in the computer system or an external data base.

80. The method of claim 50, wherein the dialogue object is adapted to detect events generated by other dialogue objects or the computer system and/or to execute the dialogue control in dependence of a detected event.

81. The method of claim 80, wherein the dialogue object is further adapted to save a status of the dialogue control, to interrupt the dialogue control in dependence of a first detected event, and to continue the dialogue control using the saved status in dependence of a second detected event.

82. The method of claim 50, wherein the dialogue object is extended by orthogonal characteristics for help, error-handling, speech and speech character functions.

83. The method of claim 82, wherein the orthogonal characteristics are describable in the form of meta data and the orthogonal characteristics are inheritable to other dialogue objects.

84. The method of claim 82, wherein the orthogonal characteristics are modifyable at run-time/call time of the dialogue.

85. A computer program product having a storage medium for storing programming code containing instructions capable of causing a processor, when executing the instructions, to build up a dialogue control to be implemented in a computer system, said dialogue control controlling the computer system to output requests to a dialogue partner and evaluate input from the dialogue partner in reaction to the requests, the dialogue control being built up by:
receiving an input from a user for selecting a dialogue object, a dialogue object being a data element with at least one data field, the contents of said at least one data field specifying a request to the dialogue partner or a parameter influencing how an input from the dialogue partner is evaluated during execution of the dialogue control; and
receiving an input from the user for defining the content of at least one data field of the selected dialogue object,
wherein the dialogue object is adapted to control the computer system during execution of the dialogue control in dependence of the selected dialogue object and the defined content of the at least one data field of the selected dialogue object.

86. The apparatus of claim 85, wherein the content of at least one data field of the selected dialogue object is defined by inputting a sequence of letters suitable for being converted into spoken language by a device of the computer system for speech synthesis during the execution of the dialogue control, and outputting the converted sequence of letters to the dialogue partner.

87. The apparatus of claim 85, wherein the content of the at least one data field of the selected dialogue object is defined by inputting an audio file or a reference link to an audio file, said audio file being suitable for being played by an audio file play unit of the computer system, and outputting the audio file to the dialogue partner.

88. An apparatus for building up a dialogue control implemented in a computer system, the dialogue control controlling the computer system by outputting requests to a dialogue partner and evaluating an input from the dialogue partner in reaction to the requests, the apparatus comprising:
a dialogue storage unit for storing dialogue objects, a dialogue object being a data element having at least one data field, the content of said at least one data field specifying a request to the dialogue partner or a parameter influencing the evaluation of an input from the dialogue partner during execution of the dialogue control, wherein the dialogue objects are adapted to control the computer system in dependence of a selected dialogue object and a defined content of at least one data field of the selected dialogue object during execution of the dialogue control; and
an input unit for receiving an input for selecting a dialogue object and defining the content of the at least one data field of the selected dialogue object.

89. The apparatus of claim 88, wherein the dialogue control is a voice control controlling the computer system by outputting spoken requests to a dialogue partner and evaluating spoken input from the dialogue partner in reaction to the spoken requests.

90. The apparatus of claim 88, further comprising:
a meta data generator for generating meta data based on the selected dialogue object and the defined content of at least one data field, said meta data being suitable for generating programming code dynamically during run-time, i.e. during execution of the dialogue control, wherein execution of said programming code performs the dialogue control,
wherein said meta data is implemented in the computer system or an external data base.

91. The apparatus of claim 90, wherein the programming code is a VoiceXML (Voice Extensible Markup Language) code.

92. The apparatus of claim 88, wherein the dialogue control implemented in the computer system is a text-based dialogue control in a computer network or a mobile radio network.

93. The apparatus of claim 92, wherein the text-based dialogue control implemented in the computer system is adapted for communication with the dialogue partner according to the WAP (Wireless Application Protocol) protocol.

94. The apparatus of claim 88, further comprising:
an HTML (Hypertext Markup Language) page provision unit for providing an HTML page having a menu or input field for the selection of the dialogue object or the definition of the content of the at least one data field.

95. The apparatus of claim 88, capable of receiving spoken input via a telephone line.

96. The apparatus of claim 88, further comprising:
an identifier storage unit for storing an identifier of the selected dialogue object and of the content of the at least one data field of the selected dialogue object in a data base.

97. The apparatus of claim 88, wherein the dialogue object is a dialogue object selectable from a plurality of dialogue objects and the plurality of dialogue objects comprises a menu object which, during the execution of the dialogue control, causes the computer system to output a request to the dialogue partner for the selection of one of a plurality of menu options.

98. The apparatus of claim 88, wherein the dialogue object is a dialogue object selectable from a plurality of dialogue objects and the plurality of dialogue objects comprises a prompt object which, during the execution of the dialogue control, causes the computer system to output a message to the dialogue partner without requesting an input.

99. The apparatus of claim 88, wherein the dialogue object is a dialogue object selectable from a plurality of dialogue objects and the plurality of dialogue objects comprises a conditional object which, during the execution of the dialogue control, causes the computer system to allow for a conditional sequence control in dependence of an evaluated input from the dialogue partner.

100. The apparatus of claim 88, wherein the dialogue object is a dialogue object selectable from a plurality of dialogue objects and the plurality of dialogue objects comprises a query object which, during the execution of the dialogue control, causes the computer system to output a query to the dialogue partner and receive and evaluate a response from the dialogue partner.

101. The apparatus of claim 88, capable of receiving an input from the user for selecting a sequence dialogue object having at least two data fields for storing identifiers of other dialogue objects, thereby specifying an execution sequence of the dialogue objects.

102. The apparatus of claim 88, wherein the dialogue object further has a data field for storing conditional instructions.

103. The apparatus of claim 88, wherein the dialogue object further has a data field for storing different input data received from the dialogue partner, said different input data being to be evaluated by the computer system as being equivalent data.

104. The apparatus of claim 88, wherein the dialogue object further has a data field for storing different input data received from the dialogue partner, said different input data being to be evaluated by the computer system as different responses to a request.

105. The apparatus of claim 104, wherein the dialogue object is adapted to cause the computer system, during the execution of the dialogue control, to display a plurality of possible input data on the display of a telephone, PDA (Personal Digital Assistant) or SmartPhone of the dialogue partner.

106. The apparatus of claim 103, wherein the dialogue object is adapted to cause the computer system, during the execution of the dialogue control, to start an error handling routine if after the evaluation of an input from the dialogue partner, none of the possible inputs could be determined.

107. The apparatus of claim 88, wherein the dialogue objects are organized in an object-orientated program structure having an inheritance hierarchy.

108. The apparatus of claim 107, capable of receiving an input from the user for generating a dialogue object based on the selected dialogue object.

109. The apparatus of claim 88, wherein the dialogue object is adapted to cause the computer system to execute the dialogue control in dependence of a personal profile of the dialogue partner.

110. The apparatus of claim 88, further comprising a software-implemented help assistant for providing user guidance.

111. The apparatus of claim 88, capable of receiving an input with the aid of a text editor.

112. The apparatus of claim 90, whereby the generated programming code is a SALT (Speech Application Language Tags) code.

113. The apparatus of claim 90, whereby the generated programming code is a WML (Wireless Markup Language) code.

114. The apparatus of claim 88, further comprising:
a meta data generator for generating meta data on the basis of the selected dialogue object and the defined content of the at least one data field, the meta data being data suitable for generating programming code dynamically at run-time, i.e. during the execution of the dialogue control, said programming code being compatible to a format for the use of standard WVR (Interactive Voice Response) or voice dialogue or multimodal dialogue systems.

115. The apparatus of claim 114, wherein the meta data is implemented in the computer system or an external data base.

116. The apparatus of claim 88, wherein the dialogue object is adapted to detect events generated by other dialogue objects or the computer system and/or to execute the dialogue control in dependence of a detected event.

117. The apparatus of claim 116, wherein the dialogue object is further adapted to save a status of the dialogue control, to interrupt the dialogue control in dependence of a first detected event, and to continue the dialogue control using the saved status in dependence of a second detected event.

118. The apparatus of claim 88, wherein the dialogue object is extended by orthogonal characteristics for help, error-handling, speech and speech character functions.

119. The apparatus of claim 118, wherein the orthogonal characteristics are describable in the form of meta data and the orthogonal characteristics are inheritable to other dialogue objects.

120. The apparatus of claim 118, wherein the orthogonal characteristics are modifyable at run-time/call time of the dialogue.

121. A computer system for executing a dialogue control, comprising:
a request output unit for outputting requests to a dialogue partner; and
an evaluation unit for evaluating input from the dialogue partner in reaction to requests,
wherein the computer system is arranged for executing the dialogue control in dependence of at least one dialogue object being a data element having at least one data field, the content of said at least one data field specifying a request to the dialogue partner or a parameter influencing the evaluation of an input from the dialogue partner during execution of the dialogue control, wherein the computer system is further arranged for executing the dialogue control in dependence of the content of at least one data field.

122. The computer system of claim 121, arranged for executing a dialogue control which has been built up by receiving an input from a user for selecting a dialogue object, and receiving an input from the user for defining the content of at least one data field of the selected dialogue object.

123. The computer system of claim 121, further comprising a meta data access unit for accessing meta data describing the dialogue control and for generating programming code from the meta data during the dialogue control, wherein running the programming code causes the dialogue control to be executed.

124. The computer system of claim 121, further comprising a connection unit for connecting to a telephone to output the requests to the dialogue partner via a telephone line and receive the input from the dialogue partner via said telephone line.

125. The computer system of claim 121, further comprising a voice and dialogue control unit for performing a voice and dialogue control according to the VoiceXML (Voice Extensible Markup Language) standard.

126. The computer system of claim 121, further comprising a speech recognition unit for performing a speech recognition to evaluate the input from the dialogue partner.

127. The computer system of claim 121, further comprising a speech synthesis unit for performing a speech synthesis to convert a sequence of letters contained in a data field of a dialogue object into spoken language and output said spoken language to the dialogue partner.

128. The computer system of claim 121, further comprising a play unit for playing an audio file.

129. The computer system of claim 121, further comprising an error handler for performing an error-handling routine when no evaluation was possible after an input from the dialogue partner.

130. The computer system of claim 121, further comprising a dialogue control execution unit for executing the dialogue control in dependence of a personal profile of the dialogue partner.

131. The computer system of claim 121, arranged for outputting text on a display of a telephone, PDA (Personal Digital Assistant) or SmartPhone of the dialogue partner.

132. A method of building up a dialogue control implemented in a computer system, said dialogue control controlling the computer system by outputting requests to a dialogue partner and evaluating input from the dialogue partner in reaction to the requests, the method comprising:
receiving an input from a user for selecting a dialogue object being a data element with at least one data field, the contents of said at least one data field specifying a request to the dialogue partner or a parameter influencing how an input from the dialogue partner is evaluated during execution of the dialogue control;
receiving an input from the user for defining the content of at least one data field of the selected dialogue object, the selected dialogue object being adapted to control the computer system during execution of the dialogue control in dependence of the selected dialogue object and the defined content of the at least one data field of the selected dialogue object;
generating meta data based on the selected dialogue object and the defined content of at least one data field, said meta data being suitable for generating programming code dynamically during run-time, wherein execution of said programming code performs the dialogue control; and
implementing the meta data in the computer system or an external data base.
